(19) United States
(12) Patent Application Publication
(10) Pub. No.: US 2015/0049497 A1
(43) Pub. Date: Feb. 19, 2015

(54) Z-SHAPED LAMP PANEL

(71) Applicant: GENERAL LUMINAIRE CO., LTD., TAIPEI CITY (TW)

(72) Inventors: YUNG-HONG WANG, TAIPEI CITY (TW); HUAN-HUAN WEI, SHANDONG (CN); DAVID FITZGERALD, LONDON (GB); MARCEL NIERHOFF, FRONDENBERG (DE)

(73) Assignee: GENERAL LUMINAIRE CO., LTD., TAIPEI CITY (TW)

(21) Appl. No.: 13/965,221

(22) Filed: Aug. 13, 2013

(51) Int. Cl. F21V 21/00; F21K 99/00

(52) U.S. Cl. CPC F21V 21/00; F21K 9/00
USPC 362/382

(57) ABSTRACT

Disclosed is a Z-shaped lamp panel applied in a lamp and configured as a comb-shaped body. The Z-shaped lamp panel includes an installing portion disposed at a position corresponding to a comb-handle position and a plurality of carrying portions corresponding to comb-tooth positions respectively. The installing portion is coupled to a side of the carrying portions, and the carrying portions are arranged with an interval apart from each other and provided for installing a plurality of light emitting diodes. Therefore, the cost of the lamp panel can be reduced while the lamp can maintain the light emitting diodes in a matrix form to ensure a maximum illumination range.

### BACKGROUND OF THE INVENTION

1. Field of the Invention The present invention relates to the field of light emitting diodes (LEDs), and more particularly to a Z-shaped lamp panel for holding LED light sources, and the Z-shaped lamp panel adopts a method of changing the design of a printed circuit board (PCB) to provide the largest illumination range with the smallest using area of the PCB.

2. Description of the Related Art

The LEDs with the features of high light emitting efficiency, low power consumption and long service life hit the illumination market and are used extensively in the various types of lamps such as light bulbs, light steel framed ceiling lamps, advertising billboards, liquid crystal displays and light emitting modules used in building wall light. Therefore, it is a main subject for related manufacturers to reduce the manufacturing cost of the LED lamps and maintain the illumination brightness, operating efficiency and service life to a certain level. With reference to FIG. 1 for a light emitting module 1 used in wall lights, the light emitting module comprises a lamp base 10, a heat sink 11, a light emitting module 12, a light guide frame 13, a diffuser 14 and a lamp cover 15, and the lamp base 10 is a rectangular body for accommodating and stacking the heat sink 11, the light emitting module 12, the light guide frame 13 and the diffuser 14 sequentially and then connecting the lamp cover 15. The light emitting module 12 comprises a lamp panel 120 and a plurality of LED light sources 121, and the lamp panel 120 is generally a printed circuit board (PCB) for printing a control circuit (not shown in the figure), and the LED light sources 121 are arranged with an interval W apart from each other to fully utilize the light emitting capability of each LED light source 121 to provide the largest illumination range of the light emitting module 1. In addition, the light guide frame 13 includes a plurality of light guide walls 130 disposed at positions corresponding to the installation positions of the LED light sources 121 respectively and provided for guiding the light path of the LED light sources 121 to achieve a uniform lighting effect. Besides the light emitting module 1, the backlighting device presently used in advertising billboards and liquid crystal displays is the same. To maximize the illumination range a minimal use of LEDs and provide the competitive edge of a lower manufacturing cost, the aforementioned LED lamps adopt the design of arranging the LED light sources 121 equidistantly in a matrix form. However, such arrangement results in approximately half of the area of the lamp panel 120 remaining unused and causes a waste of the costs due to the insufficient utilization of the lamp panel 120. Obviously, the prior art requires improvements.

In view of the aforementioned drawbacks of the prior art, it is an important subject for the present invention to improve the design of a lamp panel with a PCB featuring the arrangement of the LED light sources in a matrix form to reduce the assembling cost while maximizing the illumination range of the LED lamp without affecting the configuration of the LED light sources.

### SUMMARY OF THE INVENTION

Therefore, it is a primary objective of the present invention to provide a Z-shaped lamp panel to reduce the consumption of PCB materials and achieve the effect of lowering the manufacturing cost of the components of the LED lamp.

To achieve the aforementioned objectives, the present invention provides a Z-shaped lamp panel applied in a lamp and provided for installing a plurality of light emitting diodes and a control circuit, characterized in that the Z-shaped lamp panel is a comb-shaped body and comprises an installing portion disposed at a corresponding comb-handle position and a plurality of carrying portions corresponding to the comb-tooth position, and the installing portion is coupled to a side of the carrying portions, and the carrying portions are arranged with an interval apart from each other and provided for installing the light emitting diodes.

Wherein, two opposite sides of each carrying portion are corresponding continuous curves, such that the carrying portion has a plurality of recessions and a plurality of protrusions arranged alternately with one another, and the continuous curve can be in a sawtooth shape, a wavy shape or an arc shape. Alternatively, the two opposite sides of the carrying portion can be straight liens. The carrying portions are arranged equidistantly with an equal interval apart from one another, and each interval has a width equal to the width of each carrying portion. When the lamp adopts a plurality of Z-shaped lamp panels, the carrying portion of one of the Z-shaped lamp panels is installed in the interval of another Z-shaped lamp panel to connect the Z-shaped lamp panels with each other.

In summation of the description above, the present invention adopts the design concept of evacuating the conventional lamp panel without installing the LED light source to produce a comb-shaped PCB, so that the Z-shaped lamp panel allows the light emitting diodes to be arranged into a matrix form without affecting the illumination range of the lamp. In the meantime, the invention can achieve the effects of reducing the consumption of the manufacturing material significantly, avoiding unnecessary waste of natural resources and complying with the environmental protection requirements. In addition, the comb tooth shaped carrying portions arranged with an interval apart from each other provides an effective effect of dissipating the heat generated by the light emitting diodes during the operation of the lamp and improves the heat dissipating efficiency of the lamp to ensure the illumination quality and service life.

### BRIEF DESCRIPTION OF THE DRAWINGS

FIG. 1 is an exploded view of a conventional light emitting module used in lamp walls;

FIG. 2 is a schematic view of an application in a first implementation mode of a preferred embodiment of the present invention;

FIG. 3 is a schematic view of a second implementation mode of a preferred embodiment of the present invention;

FIG. 4 is a schematic view of an application in the second implementation mode of a preferred embodiment of the present invention; and

FIG. 5 is a schematic view of another application in the second implementation mode of a preferred embodiment of the present invention.

### DETAILED DESCRIPTION OF THE PREFERRED EMBODIMENTS

The technical content of the present invention will become apparent with the detailed description of preferred embodiments and the illustration of related drawings as follows.

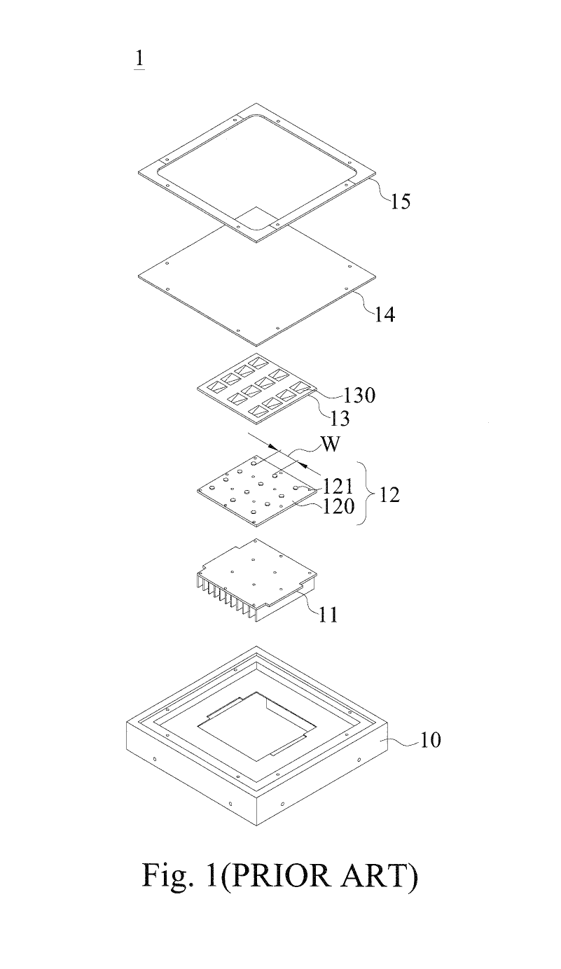

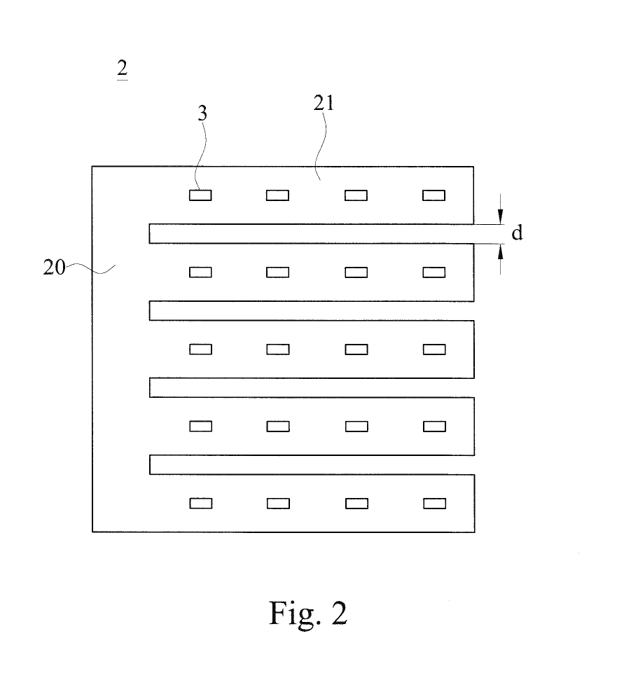

FIG. 1 is a schematic view of an application of a Z-shaped lamp panel in a first implementation mode of a preferred embodiment of the present invention. The Z-shaped lamp panel 2 is a single-layer, double-layer or multi-layer printed circuit board applicable in a lamp (not shown in the figure), such as a light steel framed ceiling lamp, an advertising billboard, a liquid crystal display and a light emitting module used in a building wall light and provided for installing a plurality of light emitting diodes 3 and a control circuit (not shown in the figure). The Z-shaped lamp panel 2 is an integrally formed comb-shaped body and comprises an installing portion 20 disposed at a position corresponding to a comb-handle position and a plurality of carrying portions 21 corresponding to the comb-tooth position, so that the installing portion 20 is coupled to a side of the carrying portions 21. The carrying portions 21 are arranged with an interval (d) apart from each other and provided for installing the light emitting diodes 3, and the opposite sides are straight lines, such that the Z-shaped lamp panel 2 has an external look of a traditional comb without a protruding handle, and the interval can be spaces having the same width or different widths.

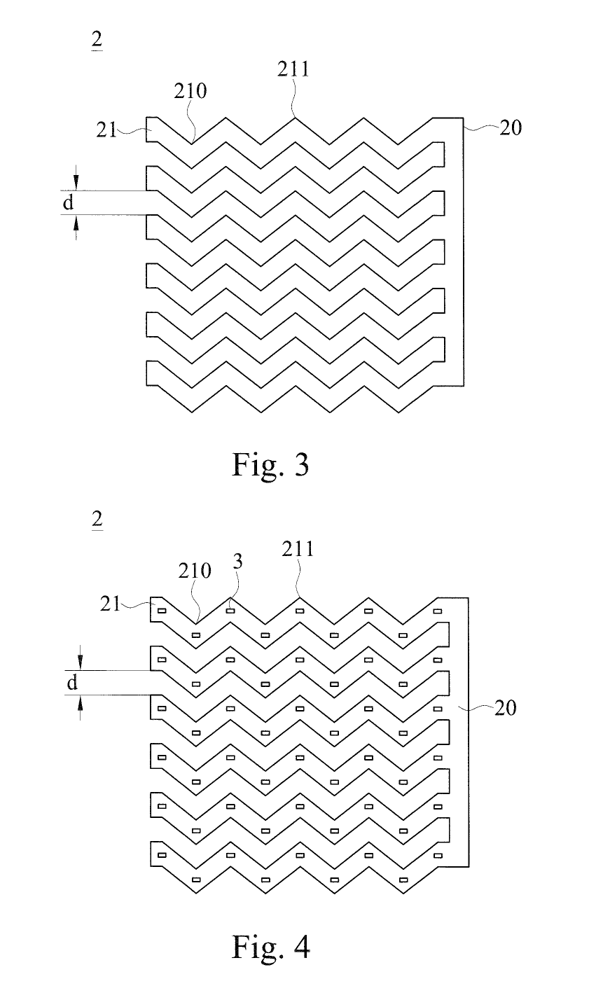

With reference to FIG. 3 for a schematic view of a second implementation mode of a preferred embodiment of the present invention, each carrying portion 21 has two opposite sides, each being a straight line or a corresponding continuous curve such as a continuous curve in a sawtooth shape, a wavy shape or an arc shape. In other words, if one of the opposite sides of the carrying portion 21 is a continuous sawtooth shaped curve with a concave tooth arranged in front of a convex tooth and so forth, then the other side is a continuous sawtooth shaped curve with a convex tooth arranged in front of a concave tooth and so forth, such that the carrying portion 21 has a plurality of recessions 210 and a plurality of protrusions 211 arranged alternately with one another.

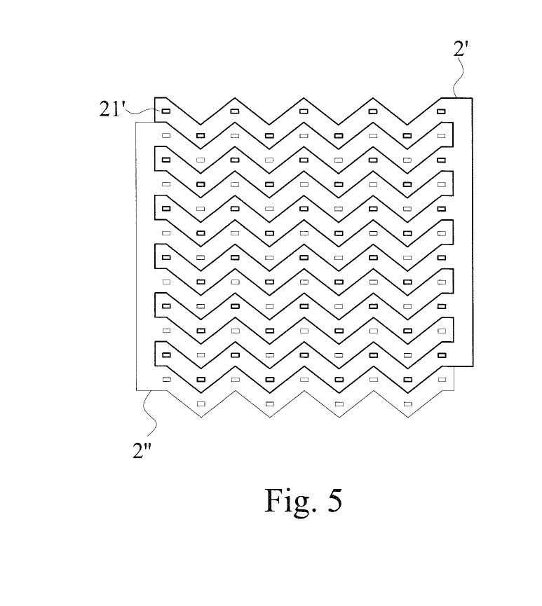

In FIG. 4, the light emitting diodes 3 are installed on the protrusions 211 respectively, and two rows of light sources are arranged alternately on a single carrying portion 21. In addition, the carrying portions 21, as shown in FIG. 5, are arranged equidistantly with an equal interval apart from one another, and each interval has a width equal to the width of each carrying portion 21, and when the lamp requires to have a high intensity of illumination per unit area and adopts a plurality of Z-shaped lamp panels 2, the carrying portion 21′ of one of the Z-shaped lamp panels 2′ is installed in the interval of another Z-shaped lamp panel 2″ in order to connect the Z-shaped lamp panels 2′, 2″ with each other. In other words, the recession of the Z-shaped lamp panel 2′ is provided for accommodating the protrusion of the Z-shaped lamp panel 2″, so that the light emitting diodes 3 in the two rows of light sources of the aforementioned carrying portion 21 can be arranged equidistantly into a matrix form by the aforementioned supplementary connection of the recessions and protrusions to facilitate the customization of the lamp and meet practical application requirements.

What is claimed is:

1. A Z-shaped lamp panel, used in a lamp and provided for installing a plurality of light emitting diodes and a control circuit, characterized in that the Z-shaped lamp panel is a comb-shaped body and comprises an installing portion disposed at a position corresponding to a comb-handle position and a plurality of carrying portions disposed at positions corresponding to the comb-tooth position, and the installing portion is coupled to a side of the carrying portions, and the carrying portions are arranged with an interval from each other and provided for installing the light emitting diodes.

2. The Z-shaped lamp panel of claim 1, wherein each carrying portion has two opposite sides, each being a continuous curve, and the carrying portion has a plurality of recessions and a plurality of protrusions disposed alternately with one another.

3. The Z-shaped lamp panel of claim 2, wherein the two opposite sides of the carrying portion being a continuous curve in a sawtooth shape, a wavy shape or an arc shape.

4. The Z-shaped lamp panel of claim 1, wherein the carrying portion has two opposite sides, each being a straight line.

5. The Z-shaped lamp panel of claim 3, wherein the carrying portions are arranged equidistantly with the interval apart from each other, and the width of the interval is equal to the width of each of the carrying portion.

6. The Z-shaped lamp panel of claim 4, wherein the carrying portions are arranged equidistantly with the interval apart from each other, and the width of the interval is equal to the width of each of the carrying portion.

7. The Z-shaped lamp panel of claim 5, wherein the carrying portion of one of the Z-shaped lamp panels is installed into the interval of another Z-shaped lamp panel to connect the Z-shaped lamp panels with one another, when the lamp adopts a plurality of Z-shaped lamp panels.

8. The Z-shaped lamp panel of claim 6, wherein the carrying portion of one of the Z-shaped lamp panels is installed into the interval of another Z-shaped lamp panel to connect the Z-shaped lamp panels with one another, when the lamp adopts a plurality of Z-shaped lamp panels.
